(19) United States
(12) Patent Application Publication
(10) Pub. No.: US 2015/0281972 A1
(43) Pub. Date: Oct. 1, 2015

(54) Network Node and Method for Handling Spectrum Bands in a Mobile Radio Communication System

(71) Applicant: Telefonaktiebolaget L M Ericsson (publ), Stockholm (SE)

(72) Inventors: Mikael Prytz, Ronninge (SE); Tim Irnich, Neuss (DE); Jörgen Karlsson, Sundbyberg (SE); Muhammad Kazmi, Bromma (SE)

(73) Assignee: Telefonaktiebolaget L M Ericsson (publ), Stockholm (SE)

(21) Appl. No.: 14/432,391

(22) PCT Filed: Oct. 2, 2012
(86) PCT No.: PCT/SE2012/051050

§ 371 Date: Mar. 30, 2015

(51) Int. Cl. H04W 16/14; H04W 28/16; H04W 72/04

(52) U.S. Cl. CPC H04W 16/14; H04W 72/0453; H04W 28/16

(57) ABSTRACT

A spectrum control node (220) and a method therein for handling spectrum bands for allocation to a mobile radio communication system (200) are disclosed. The spectrum bands are shareable with a further radio system (201) through a spectrum database node (210) for managing information about usage of the spectrum bands. The mobile radio communication system (200) comprises the spectrum control node (220) and a radio network node (230). The spectrum control node (220) determines a parameter value for indicating a condition pertaining to the radio network node (230), which condition relates to usage of at least one of the spectrum bands. When the parameter value exceeds a threshold value for the condition, whereby a need for handling at least one of the spectrum bands is indicated, the spectrum control node (220) sends, to the spectrum database node (210), a message for handling at least one of the spectrum bands.

### TECHNICAL FIELD

Embodiments herein relate to radio communication systems, such as telecommunication systems. More particularly, a spectrum control node and a method therein for handling spectrum bands are disclosed.

### BACKGROUND

In a typical communications network, also referred to as e.g. a wireless communications network, a wireless communications system, a communications network or a communications system, a device, communicates via a Radio Access Network (RAN) to one or more Core Networks (CNs).

The device is a device by which a subscriber may access services offered by an operator's network and services outside operator's network to which the operators radio access network and core network provide access, e.g. access to the Internet. The device may be any device, mobile or stationary, enabled to communicate over a radio channel in the communications network, for instance but not limited to e.g. user equipment, mobile phone, smart phone, sensors, meters, vehicles, household appliances, medical appliances, media players, cameras, or any type of consumer electronic, for instance but not limited to television, radio, lighting arrangements, tablet computer, laptop or Personal Computer (PC). The device may be portable, pocket storable, hand held, computer comprised, or vehicle mounted devices, enabled to communicate voice and/or data, via the radio access network, with another entity, such as another device.

The device is enabled to communicate wirelessly with the communications network. The communication may be performed e.g. between two devices, between device and a server via the radio access network and possibly one or more core networks and possibly the internet.

The radio access network covers a geographical area which may be divided into cell areas, and therefore the communications network may also be referred to as a cellular network. Each cell area may be served by a base station, e.g. a Radio Base Station (RBS), which in some radio access networks is also called evolved NodeB (eNB), NodeB or B node. A cell is a geographical area where radio coverage is provided by the base station at a base station site. The base stations communicate over a radio interface with the devices within range of the base stations.

The ever-increasing demand for wireless bandwidth, have made the radio frequency spectrum a scarce and expensive resource. Because the radio frequency spectrum is a finite resource in great demand, its use and availability needs to be carefully considered. In a scenario where all potentially interesting spectrum bands for mobile communication are already allocated to service, additional spectrum for communications systems is needed to cope with the exponential take-off of communications systems. At the same time traditional spectrum regulatory methods are perceived too slow to adapt to the sometimes rapidly changing economic and technical requirements, implying that large parts of the electromagnetic spectrum is licensed but not effectively used.

For example, the TV broadcast spectrum is not efficiently used due to the way the TV broadcast networks have been deployed. They are based on the concept of high transmit towers with high transmit power serving large areas with digital or analog TV. This type of deployment makes the frequency reuse distance large—in the order of 100 km—implying a spatially sparse use of the frequency band. The geographical areas where a TV frequency channel is not in use have been termed TV white space for that channel.

Motivated by the radio frequency spectrum issues, research has been performed related to the so called shared spectrum access. The goal of shared spectrum access is to use licensed but unused parts of the spectrum, e.g. the TV broadcast bands, for communication in such a way that a primary user, i.e., the user of the service provided by the license holder, is not negatively affected by the secondary transmissions.

A central idea behind shared spectrum access is thus to use already licensed/dedicated spectrum bands, or spectrum channels, for shared purposes, i.e., for communication between a secondary transmitter and a secondary receiver. As an example, TV broadcast spectrum may be used for shared purpose in the TV white spaces. The secondary user may also be referred to as a White Space Device (WSD), which is thus a device that opportunistically uses spectrum licensed for a primary service on a shared basis at times or locations where a primary user is not using the spectrum, i.e. the primary user shares its spectrum with the secondary user. As already mentioned above, the WSD is not allowed to cause harmful interference to the primary service. Furthermore, the WSD is not protected from interference from any primary service or user.

One way of discovering spectrum opportunities for shared usage to get access to e.g. the TV white spaces, i.e., perform secondary transmissions in the TV bands, is to access a centrally managed database referred to as a geo-location database. Upon a query from a secondary user or a WSD, the geo-location database provides the WSD with a list of TV channels available for shared usage, also called TV white space channels, at the location of the WSD. The WSD may provide information regarding its location and possibly also additional information in the database query. Furthermore, the WSD obtains maximum allowed transmit power levels associated with the channels available for shared usage in the response from the database. These transmit power levels are based on an estimation of how much interference that would be generated in a worst case, including a margin to take into account the aggregated interference from multiple WSD.

In a more elaborate approach, referred to as the master-slave approach, a master network node makes database requests for its associated slave WSD. In one example, the master network node is a base station (BS) and the slave WSD are the User Equipments (UE) served by the BS. The master-slave approach enables easier operation of a standard cellular system in the TV white spaces since the UEs need not send requests to the database. The master network node is responsible for allocating TV channels and associated output powers to the slave WSDs.

An example of a master-slave scenario is illustrated in FIG. 1. The shared system 20a may e.g. be an evolved Universal Terrestrial Radio Access Network (e-UTRAN) which is the radio access network of a Long Term Evolution (LTE) system. In an e-UTRAN, a UE is wirelessly connected to a radio base station (RBS) commonly referred to as an evolved NodeB (eNB). In FIG. 1, a white space enabled eNB 100a is the master node. This master node provides a certain service coverage area 110a in the LTE system. The UEs 150a-b are slave WSDs positioned within the service coverage area 110a of the master eNB 100a and are thus served or controlled by the eNB. The master eNB 100a is connected to the geo-location database 160a, typically via the Internet. The primary dedicated system 10a is in the example scenario a TV broadcast system providing a TV broadcast service to the primary/dedicated TV receivers 170a in a certain service area 130a.

The master node thus queries the geo-location database 160a for spectrum channels available for shared usage. In the response from the geo-location database, the master node also receives critical positions, and corresponding interference limits associated with the channels available for shared usage. A critical position may be defined as the point on the primary service coverage area which is closest to some point of the shared service area, this critical position thus being affected the most by interference from the shared usage. The interference limits for each critical position received from the geo-location database, corresponds to the maximally allowed aggregated interference level, generated from the master node and the associated controlled WSDs at the respective critical position.

Returning to the example in FIG. 1, a problem may be that signalling between the master node and the geo-location database may degenerate performance of the LTE system.

### SUMMARY

An object of embodiments herein is therefore to obviate at least one of the above disadvantages and to provide improved handling of spectrum bands, such as the above mentioned spectrum channels.

According to an aspect, the object is achieved by a method in spectrum control node for handling spectrum bands for allocation to a mobile radio communication system. The spectrum bands are shareable with the further radio system through a spectrum database node for managing information about usage of the spectrum bands. The mobile radio communication system comprises the spectrum control node and a radio network node. The spectrum control node determines a parameter value for indicating a condition pertaining to the radio network node, which condition relates to usage of at least one of the spectrum bands. When the parameter value exceeds a threshold value for the condition, whereby a need for handling at least one of the spectrum bands is indicated, the spectrum control node sends, to the spectrum database node, a message for handling at least one of the spectrum bands.

According to another aspect, the object is achieved by a spectrum control node configured to handle spectrum bands for allocation to a mobile radio communication system. The spectrum bands are shareable with a further radio system through a spectrum database node for managing information about usage of the spectrum bands. The mobile radio communication system comprises the spectrum control node and a radio network node. The spectrum control node comprises a processing circuit configured to determine a parameter value for indicating a condition pertaining to the radio network node, which condition relates to usage of at least one of the spectrum bands. Furthermore, the processing circuit is configured to send, to the spectrum database node, a message for handling at least one of the spectrum bands, when the parameter value exceeds a threshold value for the condition. In this manner, a need for handling at least one of the spectrum bands is indicated.

Since the spectrum control node handles the signaling from the mobile radio communication system related to access of spectrum bands instead of the spectrum database node, an amount of signaling and interaction with the spectrum database node is reduced. The spectrum bands are shared between the mobile radio communication system and the further radio system in that, at the most, only one of the systems may use the shared spectrum bands at any given time instant.

An advantage of the embodiments herein is that the interaction and signaling between the mobile radio communication system and the spectrum database node is limited to only those situations (areas, times) when it is of benefit to, or necessary for, the mobile radio communication system's radio network performance. It may be of benefit to the mobile radio communication system's performance in terms of radio network performance, such as data rates, quality of service or the like, and/or in terms of power consumption of the mobile system. Moreover, it may be necessary, to update the spectrum band(s), for the mobile radio communication system due to regulatory requirements, such as license agreements, radio emission requirements which may be varying in time or the like.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail in the following detailed description by reference to the appended drawings illustrating the embodiments and in which:

FIG. 1 is a schematic block diagram illustrating a communications network according to prior art.

FIG. 2 is a schematic block diagram illustrating embodiments of the mobile radio communications system and the further radio system.

FIG. 3 is a combined signaling and flow chart illustrating embodiments of a method in the mobile radio communications system.

FIG. 4 is a flow chart illustrating embodiment of the method in the spectrum control node.

FIG. 5 is a schematic block diagram illustrating embodiments of the spectrum control node.

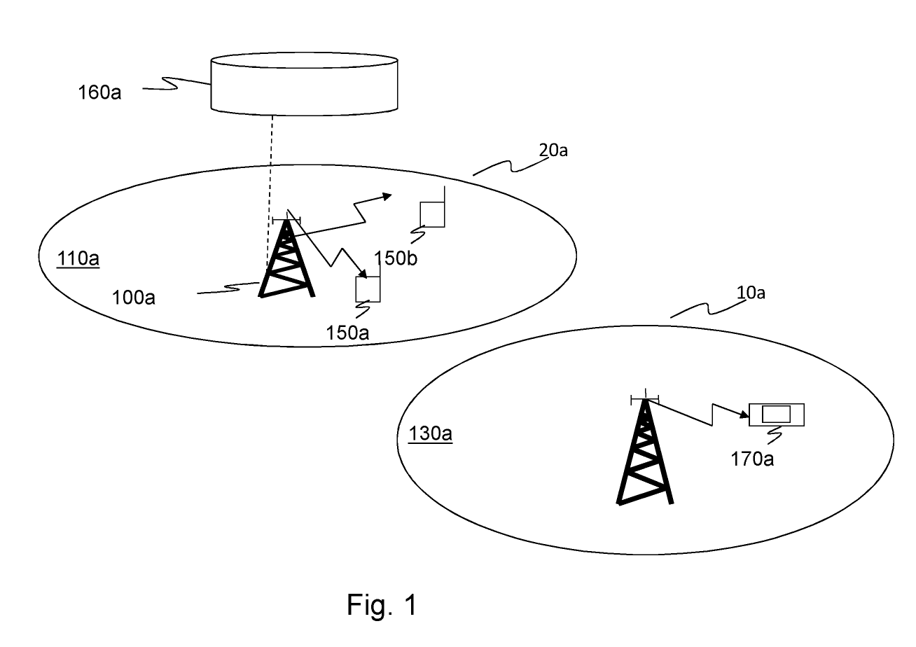

The drawings are not necessarily to scale and the dimensions of certain features may have been exaggerated for the sake of clarity. Emphasis is instead placed upon illustrating the principle of the embodiments herein.

### DETAILED DESCRIPTION

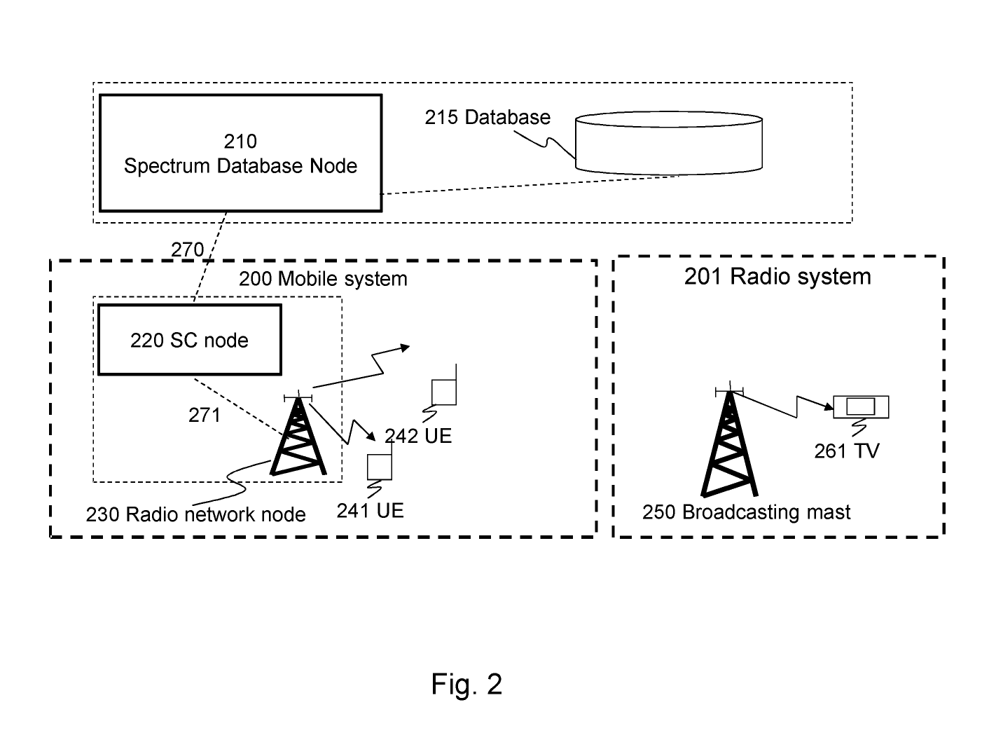

FIG. 2 depicts a mobile radio communication system 200, a further radio system 201 and a spectrum database node 210.

The mobile radio communication system 200, denoted “mobile system” in the Figure, may in some embodiments implement one or more radio access technologies such as Long Term Evolution (LTE), LTE Advanced, Wideband Code Division Multiple Access (WCDMA), Global System for Mobile Communications (GSM), or any other Third Generation Partnership Project (3GPP) radio access technology, or other radio access technologies such as e.g. a Wireless Local Area Network (WLAN).

The mobile radio communication system 200 comprises a spectrum control node 220 (SC node) and a radio network node 230.

The spectrum control node 220 is connected to the spectrum database node 210. The spectrum control node 220 may be part of an Operation and Maintenance (O & M) system, which is known from for example 3GPP radio communication systems. As further examples, the spectrum control node 220 may be a separate physical node or a logical feature of a radio base station controller or a radio base station.

The radio network node 230 transmits and/or receives transmissions on one or more so called carriers. Moreover, the radio network node 230 may be a radio base station, a radio network controller, an evolved-Node B, eNB or the like.

The radio network node 230 may communicate with user equipments 241, 242. As used herein, the term “user equipment” may refer to a mobile phone, a cellular phone, a Personal Digital Assistant (PDA) equipped with radio communication capabilities, a smartphone, a laptop or personal computer (PC) equipped with an internal or external mobile broadband modem, a tablet PC with radio communication capabilities, a portable electronic radio communication device, a sensor device equipped with radio communication capabilities or the like. The sensor may be any kind of weather sensor, such as wind, temperature, air pressure, humidity etc. As further examples, the sensor may be a light sensor, an electronic switch, a microphone, a loudspeaker, a camera sensor etc.

The further radio system 201 may also implement one or more radio access technologies as above. However, in this example, the further radio system 201 may be a TV broadcasting system.

The further radio system 201 comprises a broadcasting mast 250 for broadcasting of television (TV) transmission to at least one receiver 261 for receiving TV transmissions. The receiver 261 may be a digital TV-receiver, a television set, a DVD-player with a built in TV-receiver and the like. In examples, where the further radio system 201 implements one or more radio access technologies, the broadcasting mast 250 may be a radio network node, a radio base station, a radio network controller, an evolved-Node B, eNB or the like. In these examples, the receiver 261 may be a user equipment.

The spectrum database node 210, such a database server, may comprise, or be connected to, a database 215. The database may handle information about usage of spectrum bands. As an example, spectrum bands may refer to a frequency band, which may be defined by a first frequency value and a second frequency value. The frequency band does then extend from the first frequency value to the second frequency value. In other examples, a channeling arrangement may be deployed for a spectrum band and the frequency band is defined in terms of a channel indicator, e.g., a channel number. The database 215 may be external or internal to with respect to the spectrum database node 210. The database 215 comprises information about shared spectrum bands, which are available, in use and which have been previously offered to the database 105. This information may be in the form of e.g. a list or a table.

The information about usage of the spectrum bands may include information about which system, such as the mobile radio communication system or the further radio system, has been allocated to which spectrum band(s). Moreover, the information about usage may indicate whether a system, again such as the mobile radio communication system or the further radio system, which is allocated to a specific spectrum band, is a primary system or a secondary system with respect to the aforementioned specific spectrum band.

It should be noted that the communications links 270, 271 may be of any suitable kind including either a wired or wireless link. The communications links may use any suitable protocol, such as Protocol to Access White Space database (PAWS), depending on type and level of layer, e.g. as indicated by the Open Systems Interconnection (OSI) model, as understood by the person skilled in the art.

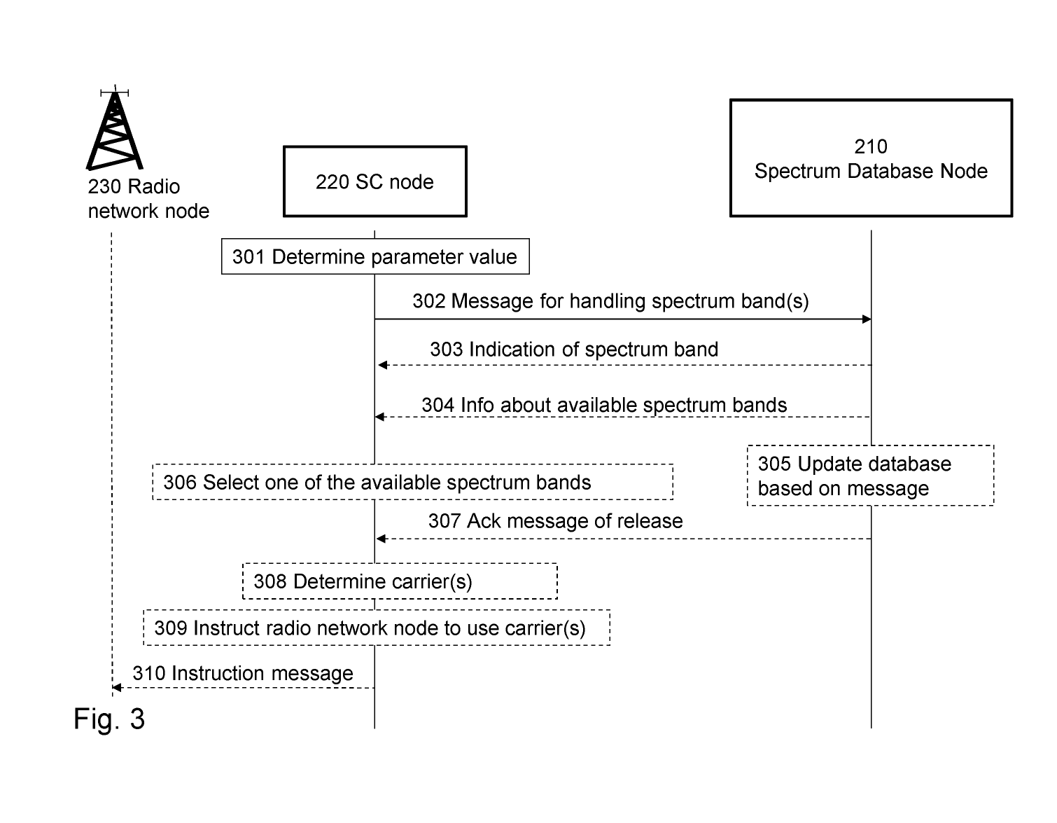

The method for handling spectrum bands in the mobile radio communication system 200 according to some embodiments will now be described with reference to FIG. 3. Hence, the spectrum control node 220 performs a method for handling spectrum bands, such as a frequency band, for allocation to a mobile radio communication system 200. The spectrum bands may refer to any spectrum band irrespectively of whether the spectrum band(s) is allocated or not allocated to the mobile radio communication system 200. The spectrum bands are shareable with the further radio system 201 through the spectrum database node 210 for managing information about usage of the spectrum bands. The mobile radio communication system 200 comprises the spectrum control node 220 and the radio network node 230.

The spectrum bands may comprise at least one dedicated spectrum band and at least one shared spectrum band. As an example, consider a first spectrum band which is dedicated to the mobile radio communication system 200 in that for example an operator has licensed the first spectrum band for use by the mobile radio communication system 200. Hence, the mobile radio communication system 200 has priority, or precedence, for using the first spectrum band. Extending the example, by considering also a second spectrum band licensed for use by a TV broadcasting system, if the second spectrum band is allowed to be temporarily used by the mobile radio communication system, the second spectrum band may be referred to as a shared spectrum band. The shared spectrum band is, consequently, shared between the TV broadcasting system and the mobile radio communication system. As previously mentioned, only one of the systems is allowed to use the second spectrum band at any given time instant. However, two secondary systems may use the same spectrum band simultaneously if the secondary system can find a way to share, for example in terms of different geographical locations of the two secondary systems, the same spectrum band among them.

The one or more spectrum bands may comprise a spectrum band dedicated to the mobile radio communication system or any available spectrum band. The any available spectrum band is determined by the spectrum database node.

The further radio system 201 may be a primary system and the mobile radio communication system 200 may be a secondary system. Referring to the example in the preceding paragraph, the mobile radio communication system 200 is a primary system with respect to the first spectrum band and the TV broadcasting system is a primary system with respect to the second spectrum band. Similarly, the mobile radio communication system 200 is a secondary system with respect to the second spectrum band. Generally, the terms “primary” and/or “secondary” is(are) determined with respect to some specific spectrum band. The term “primary” refers to the primary rights of use (which system is primarily intended to use a specific spectrum band). The term “secondary” refers to usage on a secondary basis, which means that a secondary system may be restricted in its use of a specific spectrum band, in order to protect of a primary system. In other examples, the further radio system 201 may be the secondary system and the mobile radio communication system 200 may be the primary system.

The information about usage may include information about maximum allowable transmit power for the secondary system. In this manner, it may be ensured that interference towards the primary system is acceptable. Moreover, the information about usage may include information about a geographical region in which a certain spectrum band is allocated.

The spectrum control node 220 may be represented by a separate physical node, or comprised in an Operation and Maintenance node. Furthermore, the spectrum control node 220 may comprise the radio network node 230. When the spectrum control node comprises the radio network node 230 it may mean that the embodiments herein are implemented in the radio network node 230. Giving a few examples, the actions presented herein may be performed by only the radio network node 230, by only the spectrum control node 220 or some actions may be performed by the radio network node 230 and some actions may be performed by the spectrum control node 220.

The method comprises the following steps, which steps may as well be carried out in another suitable order than described below.

### Action 301

In order for the spectrum control node 220 to be able to trigger the sending, as in action 302, of a message only when beneficial, or necessary, the spectrum control node 220 determines a parameter value for indicating a condition pertaining to the radio network node 230, which condition relates to usage of at least one of the spectrum bands.

The spectrum control node 220 may determine the parameter value internally within the spectrum control node 220 itself, or it may receive the parameter from another node in the mobile radio communication system 200, e.g. the radio network node 230.

Thanks to that the condition pertains to the radio network node 230, the condition will be related to a geographical area. The geographical area in turn corresponds to at least a portion of a coverage area, which the radio network node 230 serves, or covers. This makes it possible, for the spectrum control node, to distribute spectrum bands depending, not only on time and primary/secondary considerations, but also depending on conditions at the geographical area.

The condition may relate to one or more of a traffic load in the radio network node 230; an interference level at a spectrum band at least partially used by the radio network node 230; a number of delay tolerant sessions served by the radio network node; and a number of carriers, which are unused by the radio network node. More generally, the condition may relate to any parameter affecting usage in any manner.

The traffic load may be determined by the radio network node 230 in terms of data rates required by any user equipments served by it. For example, the traffic load may be determined e.g. by summing the required data rates, for user equipments served by the radio network node, where the required data rates apply to a scheduling period. Furthermore, the traffic load may be determined by summing a number of allocated resource blocks within a scheduling period, and possibly comparing to a number of available resource blocks, and the number of served user equipments.

The interference level is at a spectrum band at least partially used by the radio network node 230, because in some cases a carrier on which the radio network node 230 transmits/receives may correspond to e.g. a frequency band that is more narrow than the spectrum band. As a further example, the carrier may extend over two adjacent portions of two adjacent spectrum bands.

When the number of carriers, which currently are not used by the radio network node 230, exceeds a threshold for unused carriers, it may be beneficial to release any spectrum band which also is unused due to the unused carriers as seen in action 302.

The released spectrum bands will thus be available for use by e.g. the further radio system 201.

### Action 302

When the parameter value exceeds a threshold value for the condition, whereby a need for handling at least one of the spectrum bands is indicated, the spectrum control node sends, to the spectrum database node, a message for handling at least one of the spectrum bands. In this manner, the parameter value triggers the sending of the message only when the parameter value exceeds, or reaches, the threshold value. In some examples, the parameter value itself may indicate that the threshold value has been reached, or exceeded.

The threshold may be predetermined and preconfigured in the spectrum control node 220, or it may be dynamically provided to the spectrum control node 220 from e.g. the radio network node 230. The message may comprise at least one of: a request for allocating, to the mobile radio communication system 200, one or more spectrum bands from said spectrum database node 210; and a release message for releasing one or more spectrum bands currently allocated to the mobile radio communication system.

The request may indicate that the spectrum control node 220 attempts to acquire one or more spectrum bands, typically so called shared spectrum bands. Furthermore, the request may indicate that the spectrum control node 220 revokes one or more spectrum bands, typically dedicated spectrum bands. Thereby, the dedicated spectrum band(s) are only allowed to be used by the mobile radio communication system 200, since e.g. the mobile radio communication system 200 is a primary system with respect to the dedicated spectrum band(s).

The release message may indicate that the spectrum control node 220 releases, or offers, one or more spectrum bands to be used by e.g. the further radio system. The spectrum band(s) may be dedicated or shared spectrum band(s) with respect to e.g. the mobile radio communication system 200.

### Action 303

This action is preferably performed when the message comprises the request. In order for the spectrum control node 220 to be aware of which spectrum band(s) to use, the spectrum control node 220 may receive, from the spectrum database node 210, an 10 indication of a spectrum band to be allocated to the mobile radio communication system 200.

### Action 304

In many cases, the spectrum control node 220 may be allowed to allocate more 15 than one spectrum band to the mobile radio communication system 200. Therefore, the spectrum control node 220 may receive from the spectrum database node 210, information about available spectrum bands. Then, in action 306, the spectrum control node 220 uses the information about available spectrum bands.

20 Action 305

The spectrum database node 210 may update the database 215 based on the message. For example, the spectrum database node 210 may indicate that a certain spectrum band, which may be dedicated to e.g. the mobile radio communication system 200, is available for sharing with e.g. the further radio system 201. As a further example, 25 the spectrum database node 210 may indicate that another spectrum band is now allocated to the mobile radio communication system 200.

### Action 306

The spectrum control node 220 may select at least one of the available spectrum 30 bands to be used by the radio network node 230. The indication message from the spectrum database node may contain additional information about the spectrum bands, e.g., the maximum transmit power permitted in order to protect the primary radio system, which e.g. may depend on a location of where it is desired to use the spectrum band(s). The location may be related to the location of the radio network node 230.

As an example, the spectrum control node 220 may, thus, select which out of the available spectrum band to use based on geographical availability of the spectrum band, maximum allowable transmit power or the like.

### Action 307

The spectrum control node 220 may, when the message comprises the release message, receive from the spectrum database node 210, an acknowledgement message for acknowledging that the release of said one or more spectrum bands is successfully registered in the spectrum database node 210.

### Action 308

The spectrum control node 220 may determine one or more carriers to be used by the radio network node 230 based on the received indication and/or the one or more released spectrum bands according to the release message. In some examples, the spectrum control node 220 determines the one or more carriers based on spectrum bands allocated to the mobile radio communication system 200 after taking the indication and/or the one or more release spectrum bands into account. Hence, any spectrum bands not affected by the message may also form basis for the determination.

### Action 309

The spectrum control node 220 may instruct the radio network node 230 to use said one or more carriers. When the spectrum control node 220 comprises the radio network node 230, the instruction is a message sent internally within the spectrum control node 220.

In some example, the instructing may be implemented by action 310 below.

### Action 310

This action is preferably performed when the spectrum control node 220 and the radio network node 230 are separate network nodes. The spectrum control node 220 may send an instruction message for instruction the radio network node 230 to use said one or more carriers.

To conclude, an exemplary operation of the abovementioned setup is described in the following. Shared spectrum bands are made available through the spectrum database node 210. The spectrum control node 220 decides if, when, and where to use the shared spectrum bands addition to dedicated spectrum bands. The spectrum control node 220 may also decide when to release shared spectrum bands, when to revoke shared spectrum channels in order to be used as dedicated spectrum channels, when to offer dedicated spectrum channels to be used as shared spectrum channels. Further, the spectrum control node 220 may decide how to select and allocate different radio systems, such as the mobile radio communication system 200 and/or the further radio system 201, to different existing dedicated spectrum bands and shared spectrum bands.

In some embodiments, the spectrum control node 220 decides on times and locations to offer (release) its own dedicated spectrum bands to the spectrum database node 210 for shared usage, and to decide when to revoke (return) its own dedicated spectrum bands from shared usage. Sharing own dedicated spectrum bands may be of interest, e.g., when energy efficiency procedures have shut down the use of some spectrum bands, in low traffic areas, through economic incentives, by regulatory mandates, etc.

Summarized, access to spectrum bands is obtained by that signaling, between the spectrum control node 220 and spectrum database node 210, is only performed in the cases when the usage of the spectrum bands needs to be changed.

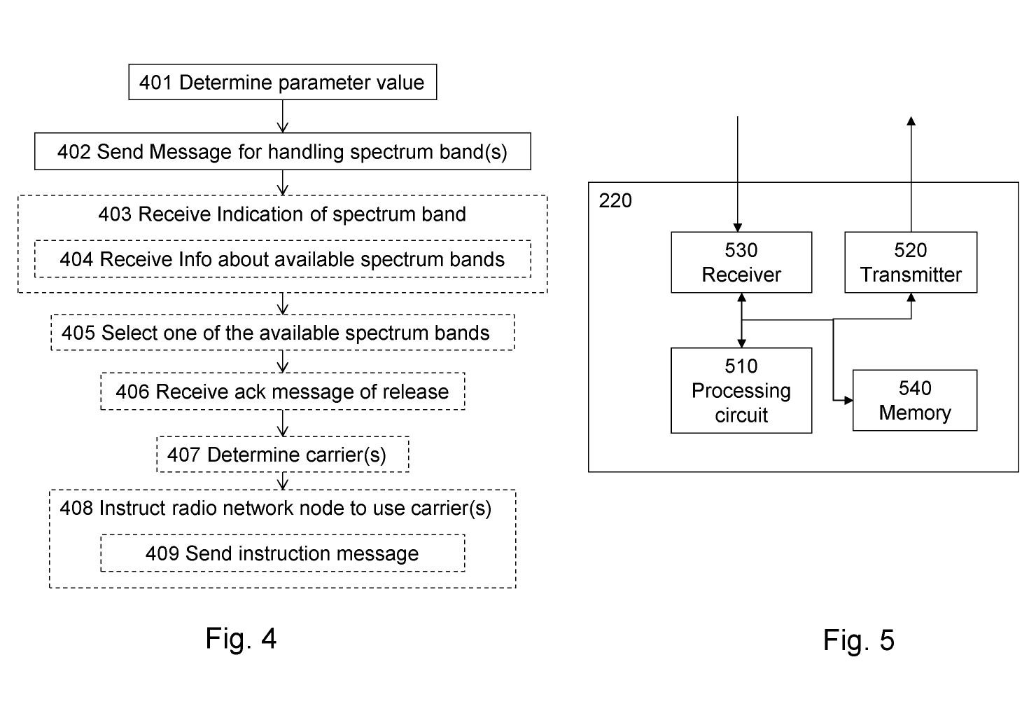

The method described above will now be described seen from the perspective of the spectrum control node 220. FIG. 4 is a flowchart describing the present method in the spectrum control node for handling spectrum bands for allocation to a mobile radio communication system 200.

As mentioned, the spectrum bands are shareable with the further radio system 201 through the spectrum database node 210 for managing information about usage of the spectrum bands. The mobile radio communication system 200 comprises the spectrum control node 220 and the radio network node 230. The spectrum bands may comprise at least one dedicated spectrum band and at least one shared spectrum band. The further radio system 201 may be a primary system and the mobile radio communication system 200 may be a secondary system. The spectrum control node 220 may be represented by separate physical node, or comprised in an Operation and Maintenance node. Furthermore, the spectrum control node 220 may comprise the radio network node 230.

The method comprises the following steps, which steps may as well be carried out in another suitable order than described below.

### Action 401

The spectrum control node 220 determines a parameter value for indicating a condition pertaining to the radio network node 230, which condition relates to usage of at least one of the spectrum bands.

The condition may relate to one or more of a traffic load in the radio network node 230; an interference level at a spectrum band at least partially used by the radio network node 230; a number of delay tolerant sessions served by the radio network node; and a number of carriers, which are unused by the radio network node.

This action is similar to action 301.

### Action 402

When the parameter value exceeds a threshold value for the condition, whereby a need for handling at least one of the spectrum bands is indicated, the spectrum control node sends, to the spectrum database node, a message for handling at least one of the spectrum bands.

The message may comprise at least one of: a request for allocating, to the mobile radio communication system 200, one or more spectrum bands from said spectrum database node 210; and a release message for releasing one or more spectrum bands currently allocated to the mobile radio communication system.

The one or more spectrum bands may comprise a spectrum band dedicated to the mobile radio communication system or any available spectrum band. The any available spectrum band is determined by the spectrum database node.

This action is similar to action 302.

### Action 403

The spectrum control node 220 may receive, from the spectrum database node 210, an indication of a spectrum band to be allocated to the mobile radio communication system 200. This action is similar to action 303.

### Action 404

The spectrum control node 220 may receive from the spectrum database node 210, information about available spectrum bands. This action is similar to action 304.

### Action 405

The spectrum control node 220 may select at least one of the available spectrum bands to be used by the radio network node 230. This action is similar to action 306.

### Action 406

The spectrum control node 220 may, when the message comprises the release message, receive from the spectrum database node 210, an acknowledgement message for acknowledging that the release of said one or more spectrum bands is successfully registered in the spectrum database node 210. This action is similar to action 307.

### Action 407

The spectrum control node 220 may determine one or more carriers to be used by the radio network node 230 based on the received indication and/or the one or more released spectrum bands according to the release message. This action is similar to action 308.

### Action 408

The spectrum control node 220 may instruct the radio network node 230 to use said one or more carriers. This action is similar to action 309.

Action 409

This action is preferably performed when the spectrum control node 220 and the radio network node 230 are separate network nodes. The spectrum control node 220 may send an instruction message for instruction the radio network node 230 to use said one or more carriers. This action is similar to action 310.

To perform the method steps shown in FIG. 3 for for handling spectrum bands in the mobile radio communications system 200 the spectrum control node 220 may be configured as illustrated in FIG. 5 and described in the following. Hence, the spectrum control node 220 is configured to handle spectrum bands for allocation to a mobile radio communication system 200. The spectrum bands are shareable with a further radio system 201 through a spectrum database node 210 for managing information about usage of the spectrum bands. The mobile radio communication system 200 comprises the spectrum control node 220 and a radio network node 230. The further radio system 201 may be a primary system and the mobile radio communication system 200 may be a secondary system.

The spectrum bands may comprise at least one dedicated spectrum band and at least one shared spectrum band.

The spectrum control node 220 may be represented by separate physical node. Furthermore, the spectrum control node 220 may be comprised in an Operation and Maintenance node.

The spectrum control node 220 may comprise the radio network node 230.

The spectrum control node 220 comprises a processing circuit 510 configured to determine a parameter value for indicating a condition pertaining to the radio network node 230, which condition relates to usage of at least one of the spectrum bands.

The condition may relate to one or more of a traffic load in the radio network node 230, an interference level at a spectrum band at least partially used by the radio network node 230, a number of delay tolerant sessions served by the radio network node, and a number of carriers, which are unused by the radio network node 230,

Furthermore, the processing circuit 510 is configured to send, to the spectrum database node 105, a message for handling at least one of the spectrum bands, when the parameter value exceeds a threshold value for the condition. In this manner, a need for handling at least one of the spectrum bands is indicated.

The message may comprise at least one of a request for allocating, to the mobile radio communication system 200, one or more spectrum bands from said spectrum database node 105, and a release message for releasing one or more spectrum bands currently allocated to the mobile radio communication system.

When the message comprises the request, said one or more spectrum bands may comprise a spectrum band dedicated to the mobile radio communication system or any available spectrum band. Said any available spectrum band may be determined by the spectrum database node 210.

The processing circuit 510 may further be configured to receive, from the spectrum database node 210, an indication of a spectrum band to be allocated to the mobile radio communication system 200, when the message comprises the request.

Additionally or alternatively, the processing circuit 510 may further be configured to receive, from the spectrum database node 210, an acknowledgement message for acknowledging that the release of said one or more spectrum bands is successfully registered in the spectrum database node 210, when the message comprises the release message.

The processing circuit 510 may further be configured to determine one or more carriers to be used by the radio network node 230 based on the received indication and/or the one or more released spectrum bands according to the release message; and to instruct the radio network node 230 to use said one or more carriers.

The processing circuit 510 may further be configured to receive, from the spectrum database node 210, information about available spectrum bands; and to select at least one of the available spectrum bands to be used by the radio network node 230.

The spectrum control node 220 may further comprise a transmitter 520, which may be configured to send one or more of the message, and the instruction message and other numbers, values or parameters described herein.

The spectrum control node 220 may further comprise a receiver 530, which may be configured to receive one or more of the indication, the information about available spectrum bands and the acknowledgement message and other numbers, values or parameters described herein.

The transmitter/receiver 520, 530 may be any unit capable of sending and/or receiving information to/from the spectrum control node 220. The information may be sent over a wired, or a wireless interface, such as a radio interface. The transmitter may be a sending unit for sending over the wired interface or a radio transmitter for sending over the radio interface. The receiver may be a receiving unit for receiving over the wired interface or a radio receiver for receiving over the radio interface.

The spectrum control node 220 may further comprises a memory 540 for storing software to be executed by, for example, the processing circuit. The software may comprise instructions to enable the processing circuit to perform the method in the spectrum control node 220 as described above in conjunction with FIG. 3 and/or 4. The memory may be a hard disk, a magnetic storage medium, a portable computer diskette or disc, flash memory, random access memory (RAM) or the like. Furthermore, the memory may be an internal register memory of a processor.

Those skilled in the art will also appreciate that the transmitter and the receiver described above may refer to a combination of analog and digital circuits, and/or one or more processors configured with software and/or firmware, e.g. stored in a memory, that when executed by the one or more processors such as the processing circuit perform as described above.

In some embodiments, some or all of the functionalities described above as being provided by the spectrum control node 220 may be provided by the processing circuit executing instructions stored on a computer-readable medium, such as the memory shown in FIG. 5. Alternative embodiments of the spectrum control node may comprise additional components beyond those shown in FIG. 5 that may be responsible for providing certain aspects of the spectrum control node's functionality, including any of the functionality described above and/or any functionality necessary to support the embodiments described above.

The described embodiments may be implemented in any appropriate type of communications system supporting any suitable communication standards and using any suitable components.

The embodiments herein are not limited to the above described embodiments. Various alternatives, modifications and equivalents may be used. Therefore, the above embodiments should not be taken as limiting the scope of the embodiments, which is defined by the appending claims.

As used herein, the terms “number”, “value” may be any kind of digit, such as binary, real, imaginary or rational number or the like. Moreover, “number”, “value” may be one or more characters, such as a letter or a string of letters. “number”, “value” may also be represented by a bit string.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

It should also be emphasised that the steps of the methods defined in the appended claims may, without departing from the embodiments herein, be performed in another order than the order in which they appear in the claims.

1. A method in a spectrum control node for handling spectrum bands for allocation to a mobile radio communication system, wherein the spectrum bands are shareable with a further radio system through a spectrum database node for managing information about usage of the spectrum bands, wherein the mobile radio communication system comprises the spectrum control node and a radio network node, the method comprising:
determining a parameter value for indicating a condition pertaining to the radio network node, which condition relates to usage of at least one of the spectrum bands; and
when the parameter value exceeds a threshold value for the condition, whereby a need for handling at least one of the spectrum bands is indicated, sending, to the spectrum database node, a message for handling at least one of the spectrum bands.

2. The method according to claim 1, wherein the message comprises at least one of:
a request for allocating, to the mobile radio communication system, one or more spectrum bands from said spectrum database node;
a release message for releasing one or more spectrum bands currently allocated to the mobile radio communication system.

3. The method according to claim 2, when the message comprises the request, wherein said one or more spectrum bands comprises a spectrum band dedicated to the mobile radio communication system or any available spectrum band, wherein said any available spectrum band is determined by the spectrum database node.

4. The method according to claim 1, further comprising:
when the message comprises the request, receiving, from the spectrum database node, an indication of a spectrum band to be allocated to the mobile radio communication system; and/or
when the message comprises the release message, receiving, from the spectrum database node, an acknowledgement message for acknowledging that the release of said one or more spectrum bands is successfully registered in the spectrum database node.

5. The method according to claim 4, further comprising:
determining one or more carriers to be used by the radio network node based on the received indication and/or the one or more released spectrum bands according to the release message; and
instructing the radio network node to use said one or more carriers.

6. The method according to claim 4, wherein the receiving of the indication of a spectrum band to be allocated to the mobile radio communication system further comprises:
receiving, from the spectrum database node information about available spectrum bands; and wherein the method further comprises:
selecting at least one of the available spectrum bands to be used by the radio network node.

7. The method according to claim 1, wherein the condition relates to one or more of:
a traffic load in the radio network node;
an interference level at a spectrum band at least partially used by the radio network node;
a number of delay tolerant sessions served by the radio network node; and
a number of carriers, which are unused by the radio network node.

8. The method according to claim 1, wherein the further radio system is a primary system and the mobile radio communication system is a secondary system.

9. The method according to claim 1, wherein the spectrum bands comprise at least one dedicated spectrum band and at least one shared spectrum band.

10. The method according to claim 1, wherein the spectrum control node is:
represented by separate physical node, or
comprised in an Operation and Maintenance node.

11. The method according to claim 1, wherein the spectrum control node comprises the radio network node.

12. A spectrum control node configured to handle spectrum bands for allocation to a mobile radio communication system wherein the spectrum bands are shareable with a further radio system through a spectrum database node for managing information about usage of the spectrum bands, wherein the mobile radio communication system comprises the spectrum control node and a radio network node, wherein the spectrum control node comprises:
a processing circuit configured to:
determine a parameter value for indicating a condition pertaining to the radio network node, which condition relates to usage of at least one of the spectrum bands; and
send, to the spectrum database node, a message for handling at least one of the spectrum bands, when the parameter value exceeds a threshold value for the condition, whereby a need for handling at least one of the spectrum bands is indicated.

13. The spectrum control node according to claim 12, wherein the message comprises at least one of:
a request for allocating, to the mobile radio communication system, one or more spectrum bands from said spectrum database node; and
a release message for releasing one or more spectrum bands currently allocated to the mobile radio communication system.

14. The spectrum control node according to claim 13, when the message comprises the request, wherein said one or more spectrum bands comprises a spectrum band dedicated to the mobile radio communication system or any available spectrum band, wherein said any available spectrum band is determined by the spectrum database node.

15. The spectrum control node according to claim 12, wherein the processing circuit further is configured to:
receive, from the spectrum database node, an indication of a spectrum band to be allocated to the mobile radio communication system, when the message comprises the request; and/or
receive, from the spectrum database node, an acknowledgement message for acknowledging that the release of said one or more spectrum bands is successfully registered in the spectrum database node, when the message comprises the release message.

16. The spectrum control node according to claim 15, wherein the processing circuit further is configured to:
determine one or more carriers to be used by the radio network node based on the received indication and/or the one or more released spectrum bands according to the release message; and
instruct the radio network node to use said one or more carriers.

17. The spectrum control node according to claim 15, wherein the processing circuit further is configured to:
receive, from the spectrum database node, information about available spectrum bands; and
select at least one of the available spectrum bands to be used by the radio network node.

18. The spectrum control node according to claim 12, wherein the condition relates to one or more of:
a traffic load in the radio network node
an interference level at a spectrum band at least partially used by the radio network node
a number of delay tolerant sessions served by the radio network node; and
a number of carriers, which are unused by the radio network node.

19. The spectrum control node according to claim 12, wherein the further radio system is a primary system and the mobile radio communication system is a secondary system.

20. The spectrum control node according to claim 12, wherein the spectrum bands comprise at least one dedicated spectrum band and at least one shared spectrum band.

21. The spectrum control node according to claim 12, wherein the spectrum control node is:
represented by separate physical node, or comprised in an Operation and Maintenance node.

22. The spectrum control node according to claim 12, wherein the spectrum control node comprises the radio network node.
